(19) United States
(12) Patent Application Publication
(10) Pub. No.: US 2026/0159732 A1
(43) Pub. Date: Jun. 11, 2026

(54) 2K Curable Compositions for Composite and Tool Release

(71) Applicant: Henkel AG & Co. KGaA, Duesseldorf (DE)

(72) Inventors: Chih-Min Cheng, Westford, MA (US); Shuhua Jin, Cheshire, CT (US); Yalin Liu, Rocky Hill, CT (US); Zhongwei Liu, Newington, CT (US); Christopher J. Verosky, Coventry, CT (US); Kevin J. Welch, Wallingford, CT (US)

(21) Appl. No.: 18/707,652

(22) PCT Filed: Sep. 9, 2022
(86) PCT No.: PCT/US2022/076171

§ 371 Date: May 6, 2024

Related U.S. Application Data
(60) Provisional application No. 63/281,278, filed on Nov. 19, 2021.

(51) Int. Cl. C09J 133/08; C08K 5/37; C09J 11/06; C09J 11/08

(52) U.S. Cl. CPC C09J 133/08; C08K 5/37; C09J 11/06; C09J 11/08

(57) ABSTRACT

The present disclosure relates generally to two part adhesive compositions comprising a thiol part including a component having thiol functionality and a (meth)acrylate functional part including a polyolefin polymer having (meth)acrylate functionality. When mixed the compositions cure to a form that provides hardness but relatively low bond strength to a substrate and which can be removed from metal and other surfaces easily and simply with little residue.

### FIELD

The present disclosure relates generally to two part adhesive compositions comprising a first thiol part including a thiol functional polymer and a second (meth)acrylate functional part including a (meth)acrylate functional polyolefin polymer. When mixed the compositions cure to a form that provides hardness but relatively low bond strength to a substrate and which can be removed from metal and other surfaces easily and simply with little residue.

### Brief Description of Related Technology

Molding and curing composite materials into desired shapes is well known. One example is disposing layers of polyester resin saturated glass fiber reinforcing material into a mold. Once cured the article is removed from the mold. One problem is the resin will strongly bond to the mold surface, permanently bonding the cured article to the mold. To prevent this a release agent must be applied to the mold surface before layup. The resin will not bond to the release agent allowing the cured article to release from the mold. release agent is typically applied to the mold before each use.

Molds are expensive to produce. Molds for items such as a boat hull or wind turbine blade are large and require substantial room to store and move. There is a benefit to minimizing mold inventory. One way to reduce mold inventory is to create molds that can be used to form a range of articles. For example, a mold can be produced to form a large panel. Temporarily blocking off sections of the mold allows a user to make smaller panels or larger panels or panels with holes for windows or fittings with only one mold.

Temporarily blocking off sections of a mold is difficult. The blocking material must seal to the mold to prevent molding resin movement into unwanted areas. The blocking material must be able to take on complex shapes, fill in small or finely detailed areas and remain in place on vertical portions. The blocking material must be sufficiently hard to support the composite molding materials during the layup and curing process without excessive deflection or movement even in applications using pressure or vacuum to force the uncured composite molding material into the mold. The blocking material must retain these properties at high temperatures in embodiments where the mold and composite molding material is heated for curing. Paradoxically, while the blocking material must adhere to the mold, it must also be readily and almost completely removable from both the mold and cured composite article without use of special operations or tools or solvents so that the mold can be reused with little work. For this reason, it is desirable for the blocking material to have an adhesion failure mode where the bond strength of the cured blocking material to the mold is lower than both the strength of the mold material and lower than the strength of the cured blocking material. Adhesive failure provides a desirable clean separation of most or all of the cured blocking material from the surface of the mold. Paradoxically, it is desirable for the cured blocking material to have sufficient cohesive strength to be removed from the mold in substantially large pieces and ideally in one piece.

Conventional curable adhesive materials are based on polyurethane, epoxy, acrylate or other chemistries. Conventional curable adhesive materials cannot provide the properties necessary for use as a mold blocking material. For example, commercial adhesive compositions based on epoxy resins are well known for providing cured bonds having substrate bond strengths of 2,000 psi or more. Conventional epoxy adhesives are also designed to provide a cohesive failure mode, e.g. the cured adhesive fails internally leaving cured adhesive strongly bonded to adherend surfaces. The cohesive failure mode is desirable in epoxy adhesives used in structural bonding applications as it is a reliable indicator of the ultimate load to which the cured bond can safely be used. The high strength and cohesive failure mode allows conventional epoxy adhesives to be used in structural composite materials used in high load applications such as boats and aircraft. A conventional curable adhesives are not suitable for use as a blocking material as they would strongly bond to the mold surface and the cohesive failure mode would make removal of the cured blocking material from the mold difficult or impossible, leading to costly reworking or loss of the mold.

Curable silicone adhesives can provide lower adhesion strength. However, some silicone materials can migrate and cause adhesion problems with later curable materials.

The composite molding material can also strongly bond to the cured mold blocking material, making removal of the cured part from the mold difficult. Using mold release can help ease removal of the cured part from the mold and/or cured blocking material. However, applying mold release adds an additional labor intensive step to the molding operation. Further, the blocking material must be cured before the mold release can be applied adding unwanted complexity and time to the molding operation.

There remains a need for a curable blocking material that can satisfy most or all of the above requirements.

### SUMMARY

One aspect of the disclosure provides a satisfactory two part, curable blocking material comprising a first part including a thiol compound and a second part including a (meth)acrylate functional polyolefin polymer.

In one embodiment the thiol compound has a thiol functionality greater than or equal to 2.

In one embodiment the (meth)acrylate functional polyolefin polymer comprises a phenoxy alkyl (meth)acrylate functional group.

In one embodiment the two component, curable blocking material has a room temperature cured hardness of at least 15 Shore A and/or a heated cure hardness of at least 30 Shore A and/or a bonding strength of no more than 1000 psi, preferably less than 600 psi and more preferably less than 300 psi, when tested using a lap shear test and the lap shear test sample exhibits at least some adhesive failure.

In one embodiment the two component, curable blocking material is free of silicone polymers and siloxane polymers.

### DETAILED DESCRIPTION

The singular forms “a”, “an” and “the” include plural referents unless the context clearly dictates otherwise.

About or “approximate” as used herein in connection with a numerical value refer to the numerical value ±10%, preferably ±5% and more preferably ±1% or less.

“Actinic radiation” includes radiation having a wavelength from about 200 nm to about 1,000 nm. Useful actinic radiation includes, but is not limited to, UVA (about 320 nm to about 410 nm), UVB (about 290 nm to about 320 nm), UVC (about 220 nm to about 290 nm) and visible light (about 450 nm to about 550 nm).

“Aryl” used alone or as part of a larger moiety as in “aralkyl”, “arylalkoxy”, or “aryloxyalkyl”, refers to mono-cyclic and polycyclic ring systems having a total of five to 20 ring members, wherein at least one ring in the system is aromatic and wherein each ring in the system contains three to twelve ring members. Aryl includes, but is not limited to, phenyl, biphenyl, naphthyl, anthracyl, any of which may include one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like.

“Comprising”, “comprises” and “comprised of” as used herein are synonymous with “including”, “includes”, “containing” or “contains”, and are inclusive or open-ended and do not exclude additional, non-recited members, elements or method steps.

“Cure” refers to both crosslinking and curing. “Crosslinking” is defined as the formation of chemical or physical interactions between polymer chains. The term “curing” is broader than the term “crosslinking” and includes the total polymerization process from initiation of the reaction to when the final reaction products are produced.

“Essentially free” is intended to mean herein that the applicable group, compound, mixture or component constitutes less than 0.1 wt. %, based on the weight of the defined composition. “Free of”, as used in this context, means that the amount of the corresponding substance in the reaction mixture is less than 0.05 wt. %, preferably less than 0.01 wt. %, more preferably less than 0.001 wt. %, based on the total weight of the reaction mixture.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

“Substantially” refers to more than 70%, preferably more than 80%, more preferably more than 90% of the recited property.

The molecular weights given in the present text refer to number average molecular weights (Mn), unless otherwise stipulated. Molecular weight data can be obtained by gel permeation chromatography (GPC) calibrated against polystyrene standards in accordance with DIN 55672-1:2007-08 at 35° C., unless otherwise stipulated. The weight average molecular weight Mw can be determined by GPC, as described for Mn.

“(Meth)acrylate refers to acrylate and methacrylate.

“Oligomer” as used herein refers to relatively low molecular weight polymeric compounds which include at least two monomer units linked to each other. Desirably the oligomer includes from 2 to 300 monomer units linked to each other. An oligomer is a subset of the term polymer. “Polymer” refers to both oligomers and any polymerized product greater in chain length and molecular weight than the oligomer.

“One or more”, as used herein, relates to at least one and comprises 1, 2, 3, 4, 5, 6, 7, 8, 9 or more of the referenced species. Similarly, “at least one” means one or more, i.e. 1, 2, 3, 4, 5, 6, 7, 8, 9 or more. “At least one”, as used herein in relation to any component, refers to the number of chemically different molecules, i.e. to the number of different types of the referenced species, but not to the total number of molecules. For example, “at least one polyol” means that at least one type of molecule falling within the definition for a polyol is used but that also two or more different polyol types falling within this definition can be present but does not mean that only one type of said polyol is necessarily present.

Room temperature is about 23° C. plus or minus 2° C.

“Substituted” refers to the presence of one or more substituents on a molecule in any possible position. Useful substituents are those groups that do not significantly diminish the disclosed reaction. Exemplary substituents include, for example, H, halogen, (meth)acrylate, epoxy, oxetane, urea, urethane, N₃, NCS, CN, NCO, NO₂, NX₁X₂, OX₁, C(X₁)₃, C(halogen)₃, COOX₁, SX₁, Si(OX₁)ᵢ(X₂)₃₋ᵢ, alkyl, alcohol, alkoxy; wherein X₁ and X₂ each independently comprise H, alkyl, alkenyl, alkynyl or aryl and I is an integer from 0 to 3.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

Unless explicitly indicated otherwise, all percentages that are cited in connection with the compositions described herein refer to weight percent (wt. %) with respect to final composition with all components.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein a curable, one part (1K) composition is a singular formulation that has sufficient commercial stability to be prepared, warehoused and shipped to an end user as a singular formulation. The 1K composition can be used without adding any additional components and will crosslink or cure when exposed to suitable conditions. As used herein a two part (2K) composition has two or more parts. Each of the parts is prepared, warehoused and shipped separately from the other part(s). The parts are mixed immediately prior to use. Mixing of the parts starts a cure reaction so commercial storage after mixing is not possible.

In one embodiment the blocking material is a cured reaction product of a mixed, 2K composition. The 2K curable composition includes a thiol part and a (meth)acrylate functional part. The two parts are mixed to initiate curing of the mixed composition.

### Thiol Part

The thiol part includes organic compounds having the —S—H thiol functional group therein. Preferably, the thiol functional compound comprises two or more —S—H thiol groups in the molecule. Typically, at least two of the —S—H thiol groups will be terminal in the molecule.

Examples of suitable thiol functional compounds include, but are not limited to, pentaerythritol tetrakis(3-mercaptopropionate); ethoxylated pentaerythritol tetrakis (3-mercaptopropionate); thiol-functionalized polydimethyl siloxanes; thiol-terminated polysulfides; dipentaerythritol hexakis thioglycolate; trimethylolpropane tris (2-mercaptoacetate); pentaerythritol tetrakis (2-mercaptoacetate); tripentaerythritol octakis thioglycolate; mercaptan-terminated propoxylated glycerol polymer (Capcure 3-800 from Huntsman); and ethyleneglycol bis (3-mercaptopropionate).

### (Meth)Acrylate Functional Part

The (meth)acrylate functional part comprises a (meth)acrylate functional polymer including one or more polyolefin segments and two or more (meth)acrylate functional groups. Useful polyolefin segments include, for example, polybutylene, polyisobutylene, polybutadiene and polyisoprene. In some embodiments the (meth)acrylate functional part is free from (meth)acrylate functional urethanes. The (meth)acrylate functional groups can be pendant or terminal on the polymer and can include a linking moiety between the polymer backbone and the (meth)acrylate group(s).

In one embodiment the (meth)acrylate functional polymer comprises repeating polyisoprene segments and the (meth)acrylate functional group is joined to the polymer by an ester linking group. Examples of this embodiment include UC-102M and UC-203M, both available from Kuraray Co. Ltd.

In another embodiment the (meth)acrylate functional polymer comprises a polyisobutylene segment and the (meth)acrylate functional group is terminally positioned from the polyisobutylene segment. In some variations the (meth)acrylate group is joined to the polymer by a-(phenyl-O-alkyl)-linking group. In some variations the (meth)acrylate functional polymer comprises two terminally positioned (meth)acrylate groups, each linked to a polyisobutylene segment by a-(phenyl-O-alkyl)-linking group. Each polyisobutylene segment can be bonded to an aryl moiety, preferably a phenyl moiety, with the polyisobutylene segments in a meta or para relationship. Preparation of these (meth)acrylate functional polymers is known. See, for example, U.S. Patent Publication US20150337067 and U.S. Patent Publication US20160083487, the contents of each of which are incorporated by reference herein.

### Reactive Diluent

The 2K composition can optionally comprise a (meth)acrylate functional, low viscosity of about 2 to about 400 cP at 25° C., reactive diluent. In some preferred embodiments the reactive diluent is present in the (meth)acrylate part to lower viscosity of the mixed composition and enhance properties of the mixed composition's cured reaction products. The reactive diluent is crosslinked into the cured composition and therefore cannot migrate from the cured composition during subsequent layup of a part using the mold. Known monomers and oligomers comprising one or more (meth)acrylate functional groups can be used. Preferably monomers and oligomers are polyfunctional, e.g. they comprise two or more (meth)acrylate functional groups to allow crosslinking within the cured composition. While methacrylate or acrylate monomers and oligomers can be used, methacrylate monomers and oligomers are preferred as they provide an advantageously slower reaction speed during curing. The reactive diluent should be compatible with the other composition components, including the (meth)acrylate functional polymer. Useful (meth)acrylate containing monomers and oligomers include isobornyl acrylate, lauryl acrylate, polyethylene glycol diacrylate, dipropylene glycol diacrylate, 1, 6 hexanediol dimethacrylate, 1, 12 dodecanediol dimethacrylate and tricyclodecane diacrylate.

### Filler

The curable composition can optionally comprise filler. When used, the filler can be the thiol part, the (meth)acrylate functional part or both. Preferably, the composition includes filler in one or both parts.

Some useful fillers include, for example, lithopone, zirconium silicate, hydroxides, such as hydroxides of calcium, aluminum, magnesium, iron and the like, diatomaceous earth, carbonates, such as sodium, potassium, calcium, and magnesium carbonates, coated calcium carbonate, oxides, such as zinc, magnesium, chromic, cerium, zirconium and aluminum oxides, calcium clay, nanosilica, fumed silicas, silicas that have been surface treated, for example with a silane or silazane such as the AEROSIL® products available from Evonik Industries, or with an acrylate or methacrylate such as AEROSIL® R7200 or R711 available from Evonik Industries, precipitated silicas, untreated silicas, graphite, synthetic fibers, organoclays such as Cloisite® nanoclay sold by Southern Clay Products, exfoliated graphite such as xGnP® graphene nanoplatelets sold by XG Sciences, zeolites, bentonites, alumina, sand, quartz, flint, mica, powdered glass and other ground minerals, carbon black, graphite, wood fibers, wood flour, sawdust, cellulose, cotton, pulp, wood chips, chopped straw, chaff, ground walnut shells, short fibers such as glass fibers, glass filament, polyacrylonitrile, carbon fibers, Kevlar fibers, polyethylene fibers, waxes, polyethylene micropowders and polypropylene micropowders. Also useful are hollow spheres with a mineral shell or a plastic shell are suitable as fillers. These can be e.g. hollow glass spheres which are commercially available with the trade names Glass Bubbles®. Plastic-based hollow spheres are commercially available, e.g. with the names Expancel® or Dualite®.

### Catalyst and Accelerator

The curable composition can optionally include a catalyst or accelerator to help initiate the cure reaction and modify speed of the initiated reaction. Catalyst is typically added to the thiol part. In some preferred embodiments the thiol part includes catalyst or accelerator to modify cure speed of the mixed composition.

Catalyst or accelerator are typically amines such as tertiary amines. Examples of useful tertiary amine catalysts and accelerators include triethylamine; dimethylethanolamine; benzyldimethylamine; dimethylanitribenzylamine; triphenylamine; N, N-dimethyl-para-toluidine; N, N-dimethyl-ortho-toluidine; tetramethylguani-dine (“TMG”); 1,8-diazabicyclo[5.4.0]undec-7-e ne (“DBU”); 1,5-diazabicyclo[4.3.0]non-5-ene (“DBN”); 1,4-diazabicyclo[2.2.2]octane (“DABCO”); quinuclidine; ethylaminomethyl phenol; tris (dimethylaminomethyl) phenol; N, N-dihydroxyethyl-p-toluidine; N, N-diisopropylethylamine; and N, N,N′,N″,N″-pentamethyldiethylenetriamine.

### Additives:

The two-component adhesive composition can optionally contain one or more additives. Optional additives include non-reactive diluent, thixotrope or rheology modifier, antioxidant, reaction modifier, thermoplastic polymer, adhesion promoter, coloring agent, solvent, tackifier, plasticizer, photoinitiator, flame retardant, moisture scavenger, and combinations of any of the above, to produce desired functional characteristics, providing they do not significantly interfere with the desired properties of the curable composition or cured reaction products of the curable composition. In some embodiments the two-component adhesive composition is free of alkoxysilane-functionalized and/or acyloxysilane-functionalized components.

The optional non-reactive diluent is fluid at room temperature and is essentially free of moieties that will react with other components of the composition. Useful classes of non-reactive diluents include, organic solvents, especially high boiling point solvents such as xylene and phthalates such as dibutyl phthalate. Since this diluent is non-reactive it can be added to the thiol part, the (meth)acrylate functional part or both. In some embodiments the blocking material is essentially free or free of non-reactive diluent and/or solvent.

The optional coloring agent can be beneficial to allow for inspection of the applied composition. A coloring agent, for example a pigment or dye, can be used to provide a desired color beneficial to the intended application. Exemplary coloring agents include titanium dioxide, C.I. Pigment Blue 28, C.I. Pigment Yellow 53 and phthalocyanine blue BN. In some applications a fluorescent dye can be added to allow inspection of the applied composition under UV radiation. When used, the curable composition can include about 0.01% or more coloring agent by weight of total composition. The maximum amount is governed by considerations of cost and compatibility with the composition. Coloring agent can be added to the thiol part, the (meth)acrylate functional part or both.

The curable composition can optionally include solvent. The composition is preferably essentially free or free of water or aqueous solvent. In some embodiments the composition is essentially free or free of water or aqueous solvent or organic solvent. If used, solvent can be added to the thiol part, the (meth)acrylate functional part or both.

In one embodiment the resin part of the two component curable composition has the following composition. All percentages are approximate and in weight percent by weight of thiol part.

thiol functional part

| component | range 1 | range 2 |
|---|---|---|
| thiol functional compound | 30-90 | 55-80 |
| optional catalyst | 0-5 | 0-3 |
| optional filler | 0-50 | 0-40 |
| optional additives | 0-70 | 0-65 |

Typically, the thiol part components are added together, mixed and packaged. In one embodiment the thiol part is a liquid or paste having a viscosity of about 5,000 cP to about 300,000 cP at 25° C.

In one embodiment the (meth)acrylate functional part of the two component curable composition has the following composition. All percentages are approximate and in weight percent by weight of (meth)acrylate functional part.

(meth)acrylate functional part

| component | range 1 | range 2 |
|---|---|---|
| (meth)acrylate functional polymer | 20-60 | 25-40 |
| reactive diluent | 10-50 | 20-40 |
| optional catalyst | 0-5 | 0-3 |
| optional filler | 0-50 | 0-40 |
| optional additives | 0-70 | 0-65 |

Typically, the (meth)acrylate functional part components are added together, mixed to blend the components, and packaged. In one embodiment the (meth)acrylate functional part is a liquid, past or solid having a viscosity of about 5,000 cP to about 500,000 cP at 25° C.

In one embodiment the mixed curable composition has some or all of the following approximate properties.

| property | range 1 | range 2 |
|---|---|---|
| ratio¹ | 0.6-2.0 | 0.8-1.2 |
| viscosity, | 5,000-300,000 | 100,000-200,000 |
| gel time (min) | 1-30 | 4-15 |
| surface tack free time (min) | <60 | <30 |
| full cure time | 1 hr.-1 week | 24 hrs.-1 week |

¹Molar ratio of S—H groups to (meth)acrylate groups

In one embodiment useful as a blocking material the cured reaction product of the mixed curable composition has some or all of the following approximate properties.

| property | range 1 | range 2 |
|---|---|---|
| hardness¹ (Shore A) | 20-80 | 40-70 |
| thermal resistance² (Shore A) | 20-90 | 40-70 |
| Lap shear strength (psi) | <1,000 | 100-800 |
| failure mode blocking material to mold | adhesive | adhesive |
| failure mode blocking material to cured part | adhesive | adhesive |

¹After curing for 24 hours.
²After curing for 24 hours and subsequent heating at 180° C. for 2 hours.

The lap shear strength of less than or equal to 1,000 psi is substantially less than the 2,000 psi or higher strength achieved by many commercial structural adhesives. Commercial adhesives are too strong to be satisfactorily used as a mold blocking composition. However, the 1,000 psi maximum strength of the disclosed, cured compositions would generally be unsuitable for use as structural adhesive.

In some embodiments a higher hardness is more desirable as it allows the cured blocking material to be removed more easily from a mold and with less crumbling or breaking into small pieces.

A mold can have a cut out into which layup of the part is sometimes desired. For example, a mold can have a recess defined in the surface. Molding material, for example layers of resin saturated reinforcing scrim are placed over the mold and pushed into the mold. This pushes the molding material into the recess. When the molded part is removed from the mold it will have a raised surface corresponding to the mold recess.

However, in some applications it may be desirable to produce a molded part with no raised surface. The disclosed compositions can be used to modify or block off parts of the mold. The thiol part and the (meth)acrylate functional part are packaged and stored in separate containers. Just before use a portion of the thiol part and a portion of the (meth)acrylate functional part are combined and mixed to homogeneity. Mixing the two parts initiates curing of the composition. To modify or block off the mold the mixed composition is placed into the mold recess and cured. Once the blocking material has cured, layers of resin saturated reinforcing scrim are placed over the mold and pushed into the mold. The cured composition supports the layers and prevents the material from penetrating into the recess. After the molded part has cured it is removed from the mold. The molded part has a surface with no raised area.

The cured composition can be removed from the mold, typically by hand without powered tools or chemicals while leaving little or no residue on the mold.

The following examples are included for purposes of illustration so that the disclosure may be more readily understood and are in no way intended to limit the scope of the disclosure unless otherwise specifically indicated.

The proceeding description is meant to be exemplary and it is to be understood that variations and modifications may be employed without departing from the concept and intent of the invention as defined in the following claims.

### Measurement of Mixed Composition Gel Time

The mixed composition gel time was measured by mixing 2 grams of the thiol part with 2 grams of the (meth)acrylate part thoroughly. A wood probe is used to gently touch the surface of the mixed material periodically. The time at which the mixed material does not adhere to the wood probe is recorded as the gel time.

### Measurement of Surface Tack Free Time

Mix 2 grams of the thiol part with 2 grams of the (meth)acrylate part thoroughly. Test the mixed material for surface gel. When the mixed composition surface gels press a thin polyethylene film onto the surface using light finger pressure. Remove the film and check for mixed material residue on the film. The time at which the mixed material does not transfer to the polyethylene film is recorded as the surface tack free time.

### Measurement of Shore Hardness in 2K Composition

The hardness test procedure is carried out in general accordance with ASTM D2240. Mix 10 grams of the thiol part with 10 grams of the (meth)acrylate part thoroughly. The mixed material is disposed between 2 glass slides to form a 4.0 inch×0.5 inch×0.25 inch thick sample. The sample is allowed to cure about 24 hours at room temperature. The slides are removed and cured sample is tested.

### Measurement of Shore Hardness in 1K Composition

Dispense 10 grams of material between 2 glass slides to form a 4.0 inch×0.5 inch×0.25 inch thick sample. Expose the top of the sample to actinic radiation of 405 nm at an intensity of 1.7 w/cm² for about 20 seconds (an LED lamp was found useful). The slides are removed and cured sample is tested.

### Measurement of Viscosity

Viscosity was tested using a Physica MCR 301 rheometer with a PP25 cone at 10 s−1 and 25° C.

### Thermal Resistance

Samples were prepared using the Shore hardness procedure. The samples were placed in an oven preheated to 180° C. for 2 hours. After 2 hours the samples were removed from the oven, cooled to room temperature and tested for Shore hardness using the above procedure.

### Measurement of Lap Shear Strength

Compositions were mixed as described. The lap shear sample preparation and testing were based on ASTM D1002-05 or ASTM D3163. The lap shear substrate is a glass fiber reinforced epoxy substrate available as Epoxy FR-4 or G-10 Epoxy Glass from Curbell Plastics. Each substrate has a dimension is about 4 inches×1 inch×0.06 inches. The substrates were cleaned to remove dirt and oils. Adhesive was applied to a portion of one surface of a substrate. Spacers were disposed on the substrate surface to induce a 10 mil (0.010 inch) gap. 10 mil glass beads or wires were used as spacers. A second substrate surface was disposed over the adhesive and clamped to form a 1.0 inch×0.5 inch×10 mil thick bonding area. The clamped samples were cured as described above for Shore hardness testing.

The lap shear samples were tested at pulling speed 0.08 inch/minute, the tensile strength at maximum load was recorded. The provided strengths for each composition are an average of results for multiple lap shear specimens.

Failure Mode was checked after the bonded specimens were pulled apart. If the adhesive remained bonded to the specimens but the specimen failed outside the bonded area the failure modes was identified as “substrate failure”. If the adhesive was observed to adhere to all of the bonded area on both substrates, e.g. failure was within the adhesive layer, the failure mode was identified as “cohesive failure” or “cohesion failure”. If the adhesive was identified to have released from all of the bonded area on at least one of the substrates the failure mode was identified as “adhesive failure” or “adhesion failure”. If the adhesive remained bonded to some, but not all, of the bonded area the failure mode was identified as a mixed adhesive/cohesive failure. Results are reported as S (failure of substrate only); A (adhesive failure), C(cohesive failure mode) or a combination of these failure modes. Failure mode can be quantified by observation of the failure type and percent of adhesive remaining on the bonded area.

It is desirable for the cured blocking material to have an adhesive failure mode to the mold and cured part. It is desirable for the cured blocking material to have enough strength to support the mold material during the molding operation and enough cohesive strength so that the cured blocking material does not disintegrate or crumble during removal from the mold.

The following materials were used in the Examples.

| Chemical | Abbreviation |
|---|---|
| Polyisobutylene diacrylate¹, Mw about 12,000 | pibda |
| Polybutadiene methacrylate UC-203M² | UC203M |
| Polybutadiene methacrylate UC-102M² | UC102M |
| Isobornyl acrylate | IBOA |
| Lauryl acrylate | LA |
| Polyethylene glycol (200) diacrylate SR259 | SR259 |
| dipropylene glycol diacrylate SR508 | SR508 |
| 1,6-hexanediol diacrylate SR238B | SR238B |
| 1,12 dodecanediol dimethacrylate SR 262 | SR262 |
| Tricyclodecane diacrylate SR833S | SR833S |
| Mercaptan terminated polyether polymer SiH EEW 333³ | Thiol A |
| Mercaptan terminated polysulfide polymer SiH EEW 266⁴ | Thiol B |
| Silane treated fume silica | Silica |
| Stearic acid surface treated calcium carbonate | CaCO3 |
| 1,8-Diazabicyclo[5.4.0]undec-7-ene | DBU |

¹a difunctional polyisobutylene diacrylate of about 12,000 Mw prepared according to U.S. Patent Publication US20160083487.
²Available from Kuraray Co. Ltd.
³GPM 800 available from Gabriel Performance Products.
⁴QE340M available from Toray.

### Example 1: Compatibility of (Meth)Acrylate Functional Polymer with (Meth)Acrylate Reactive Diluents

(Meth)acrylate functional polymers (polyisobutylene diacrylate, UC203M and UC102M) were separately mixed with several acrylate monomers in a 50/50 weight ratio in a mixing cup using a speedmixer, respectively according to the formulation in Table 2. IBOA and LA are monofunctional hydrophobic monomers. SR508 and SR 259 are hydrophilic difunctional monomers. SR238B, SR262, SR831S are hydrophobic difunctional monomers. The appearance of the mixture in the mixing cup after sitting at room temperature for 24 hrs was recorded as follows: 1) the monomer is not miscible and phase separation is observed, 2) the monomer is miscible and shows homogeneous liquid formation, but the mixture is cloudy, 3) the monomer is miscible and shows homogeneous liquid formation, and the mixture is clear. Results are summarized in Table 2.

Polyisobutylene diacrylate shows good miscibility and clear mixture with non-polar mono functional acrylate resins IBOA and LA. It is not miscible with most diacrylate resins including polar resins SR508 and SR259, or short chain nonpolar resins SR238B and SR833S. Surprisingly, long chain aliphatic monomer SR262 is miscible with polyisobutylene diacrylate without phase separation in up to a 50 wt. % SR262 to 50 wt. % polyisobutylene diacrylate mixture although it shows some cloudiness. Miscibility improves as the wt. % of SR262 is decreased.

Polyisoprene based (meth)acrylate oligomer UC102M was tested with non-polar diacrylate monomers SR262 and SR833S and showed good miscibility and clear mixture appearance with each.

Polyisoprene based (meth)acrylate oligomer UC230M was tested with non-polar diacrylate monomers SR262 and SR833S and showed good miscibility and clear mixture appearance with each.

TABLE
polyolefin based meth(acrylate) polymer compatibility with different acrylate monomers

| Example | 1.1 | 1.2 | 1.3 | 1.4 | 1.5 | 1.6 | 1.7 | 1.8 | 1.9 | 1.10 | 1.11 |
|---|---|---|---|---|---|---|---|---|---|---|---|
| pibda¹ | 50 | 50 | 50 | 50 | 50 | 50 | 50 | | | | |
| UC-203M | | | | | | | | 50 | 50 | | |
| UC-102M | | | | | | | | | | 50 | |
| IBOA | 50 | | | | | | | | | | 50 |
| LA | | 50 | | | | | | | | | |
| SR508 | | | 50 | | | | | | | | |
| SR 259 | | | | 50 | | | | | | | |
| SR238B | | | | | 50 | | | | | | |
| SR 262 | | | | | | 50 | | 50 | | 50 | |
| SR833S | | | | | | | 50 | | 50 | | 50 |
| miscible | Yes | Yes | No | No | No | Yes | No | Yes | Yes | Yes | Yes |
| appearance | clr² | clr² | PS³ | PS³ | PS³ | cloudy | PS¹ | clr¹ | clr¹ | clr¹ | clr¹ |
| rating | 3 | 3 | 1 | 1 | 1 | 2 | 1 | 3 | 3 | 3 | 3 |

¹polyisobutylene diacrylate
²clear
³phase separation observed

### Example 2: Two Component, Curable Thiol/Acrylate Compositions and Properties

Two component, curable thiol/acrylate compositions were prepared. The (meth)acrylate functional part comprises polyolefin acrylate and hydrophobic acrylate monomers. The thiol part comprises thiol compounds. Amounts shown are in wt. % based on the entire composition. Two comparative 1K, radiation curable examples (Examples 2.1C and 2.2C) containing polyisobutylene diacrylate are also included in the following Table.

TABLE
(Meth)acrylate functional part compositions

| | 2.1C | 2.2C | 2.3 | 2.4 | 2.5 | 2.6 | 2.7 | 2.8 |
|---|---|---|---|---|---|---|---|---|
| pibda | 30 | 30 | 30 | 30 | | | | |
| UC203M | | | | | 30 | | 30 | |
| UC102M | | | | | | 30 | | 30 |
| SR262 | 30 | | 30 | | 30 | 30 | | |
| IBOA | | 30 | | 30 | | | | |
| SR833S | | | | | | | 30 | 30 |
| Omnirad | 3 | 3 | | | | | | |
| TPO-L | | | | | | | | |
| Silica | 2 | 2 | 2 | 2 | 2 | 2 | 2 | 2 |
| CaCO3 | 35 | 35 | 38 | 38 | 38 | 38 | 38 | 38 |
| Total | 100 | 100 | 100 | 100 | 100 | 100 | 100 | 100 |

In the thiol part a different amount of catalyst DBU is used in the similar composition to obtain a measurable gel time.

TABLE
Thiol functional part compositions

| | Example | | |
|---|---|---|---|
| | 2.9 | 2.10 | 11 |
| raw material | wt. % | wt. % | wt. % |
| Thiol A | 65 | 65 | 65 |
| DBU | 3 | 0.3 | 1.65 |
| Silica | 1 | 1 | 1 |
| CaCO3 | 31 | 33.7 | 32.35 |
| total | 100 | 100 | 100 |

The thiol part and the (meth)acrylate functional part were mixed as shown in the below table at a 1:1 wt. ratio to form curable compositions. Properties of the mixed composition were tested.

TABLE
Gel time and surface tack free time of two-component thiol/acrylate compositions

| | MA part | 2.3 | 2.4 | 2.5 | 2.6 | 2.7 | | 2.8 | |
|---|---|---|---|---|---|---|---|---|---|
| Thiol part | gel time | 3′00 | >24 hrs | 2′30″ | 5′00 | Gelled | | Gelled | |
| Ex. 2.9 | | | | | | when | | when | |
| | | | | | | mixing | | mixing | |
| Thiol part | tack free | 5′00 | >24 hrs | 8′00″ | 7′00 | NA¹ | | NA¹ | |
| Ex. 2.9 | time | | | | | | | | |
| SH/Acrylate | | 1.10 | 1.30 | 1.10 | 1.10 | 0.98 | | 0.98 | |
| molar ratio³ | | | | | | | | | |
| Thiol part | gel time | NT² | NT² | NT² | NT² | >1 | hour | 5 | min |
| Ex. 2.10 | | | | | | | | | |
| Thiol part | tack free | NT² | NT² | NT² | NT² | >24 | hrs | >24 | hrs |

| Ex. 2.10 | time | | | | | | | |
|---|---|---|---|---|---|---|---|---|
| SH/Acrylate | | 1.10 | 1.30 | 1.10 | 1.10 | 0.98 | | 0.98 |
| molar ratio³ | | | | | | | | |
| Thiol part | gel time | NT² | NT² | NT² | NT² | 2′00 | | NT² |
| Ex. 2.11 | | | | | | | | |
| Thiol part | tack free | NT² | NT² | NT² | NT² | >24 | hrs | NT² |

| | | | | | | | |
|---|---|---|---|---|---|---|---|
| Ex. 2.11 | time | | | | | | |
| SH/Acrylate | | 1.10 | 1.30 | 1.10 | 1.10 | 0.98 | 0.98 |
| molar ratio³ | | | | | | | |

¹not applicable
²not tested
³Molar ratio of S-H groups to (meth)acrylate groups

Among the compositions, examples 2.3, 2.5 and 2.6 containing SR262 showed the best curing performance in terms of gel time and surface tack free time. Those materials became surface tack free shortly after gellation, which is desirable for many applications.

When (meth)acrylate functional composition 2.4 (with monoacrylate IBOA) was mixed with thiol part 2.9 the mixture did not gel in any practical time. Compositions using monofunctional (meth)acrylate monomers are less preferred because of this undesirable cure profile.

When (meth)acrylate functional composition 2.7 and 2.8 (comprising diacrylate monomer SR833S) were mixed with thiol part 2.9 the mixtures gelled immediately during mixing. Tack free time for these mixtures was not able to be measured due to the almost immediate gelling.

When (meth)acrylate functional composition 2.7 and 2.8 (comprising diacrylate monomer SR833S) were mixed with thiol part 2.10 or 2.11 (each of which has a much lower catalyst concentration), each of the mixtures gelled in less than 10 minutes but didn't become tacky free even after 24 hours.

SR262 is a dimethacrylate monomer and SR833S is a diacrylate monomer. For compositions using the same amount of the same catalyst, the composition using SR262 will have a slower gel time but a faster tack free time compared to the same composition but using SR833S in place of the SR262. Thus, compositions using SR262 have more desirable properties compared to compositions using SR833S. This can be somewhat modified by use of differing amounts of catalyst for the different compositions, although tack free time for SR833S compositions will remain longer than compositions made using SR262.

The examples here demonstrate the surprising effect that reactivity of monomers has on gel time, tack free time and curing.

### Example 3 Two Component Polysulfide Polymer Thiol/(Meth)Acrylate Functional Polymer Composition

In this example, a polysulfide thiol compound (Thiol B) was used in the thiol part. Compositions are shown in the below Table. Amounts are in wt. % by weight of that part. Catalyst in this example was added into (meth)acrylate functional part. The mixing ratio is 1 thiol part: 1 (meth)acrylate functional part by weight. The molar ratio of S—H groups to (meth)acrylate groups for the 1:1 by weight mixture is 1.27:1. Gel time and tack free time properties were tested for the 1:1 mixture.

TABLE
Two-component Thiol/acrylate composition

| | Example | |
|---|---|---|
| | 3.1a | 3.1b |
| | thiol part | (meth)acrylate functional part |
| Thiol B | 60 | 0 |
| SR262 | 0 | 30 |
| DBU | 0 | 2 |
| PIBDA | 0 | 30 |
| CaCO3 | 38 | 36 |
| Silica | 2 | 2 |
| total | 100 | 100 |
| gelt time (mixture) | 3 min | |
| tack free time (mixture) | 6 min | |

Gel time and tack free time for this 2K composition was similar to the curing performance of compositions using mercaptan terminated Thiol A.

### Example 4: Adhesion and Cured Property Test of Two-Component Thiol/Acrylate Compositions and Comparative Examples

Example 4.1 was a 2 part composition comprising a 1:1 by weight mixture of the material of example 2.3 as the (meth)acrylate functional part and the material of example 2.9 as the thiol part. Example 2.1C was the comparative, 1K radiation curable composition of Example 2.1C. Example 4.3C was a comparative two component product, LOCTITE® EA E-04SS, available from Henkel Corporation. LOCTITE® EA E-04SS is a two-component, toughened, epoxy designed for structural metal, magnet, glass and plastics bonding. The LOCTITE® EA E-04SS part A resin is composed of epoxy functionalized polymer/resin/monomers, optionally fillers, pigments and etc. The LOCTITE® EA E-04SS part B hardener is composed of polymercaptan, substituted amino-phenols. Once mixed, the two-component epoxy cures at room temperature. LOCTITE® EA E-04SS has a gel time of about 4 minutes and tack free time of about 15 minutes at room temperature.

The mixed compositions were tested for lap shear tensile strength on two substrates. The one-component radiation curable material was applied on the substrate and cured by exposure to LED 405 nm light for 20s with intensity of 1.7w/cm2. The one-component radiation curable material was only tested on glass reinforced epoxy substrate due to the steel substrates not allowing actinic radiation through. Both of two-component materials were cured at room temperature for 24 hours. Surface tack free and Shore hardness tests were also performed. Depth of cure is evaluated by removing the Shore hardness bead sample and looking at the bottom of the bead to see if the material is hardened. The adhesion testing results, and other cured properties are summarized in the following Table.

TABLE
Adhesion and cured property test of two-component Thiol/acrylate
compositions and Comparative examples

| Example | 4.1 | 2.1C | 4.3C |
|---|---|---|---|
| 2K thiol part | 2.9 | none | none |
| 2K (meth)acrylate functional | 2.3 | none | none |
| part | | | |
| 1K comparative radiation | no | 2.1 | no |
| curable composition | | | |
| 2K comparative product | no | no | yes |
| Lap shear tensile strength | 160 ± 22 | 362 ± 87 | 843 ± 214 |
| (psi)- glass reinforced epoxy | | | |
| Lap shear tensile strength | 139 ± 40 | Not tested | 895 ± 249 |
| (psi)- steel | | | |
| Surface tacky free test | Tacky free | Tacky | Tacky free |
| Depth of cure | Cured all | Material at | Cured all |
| | the way | bottom not | the way |
| | through | hardened | through |
| Shore Hardness | Shore A 60 | Shore D 50 | Shore A 85 |

The results show the two-component thiol/acrylate composition of Example 4.1 had significantly lower lap shear adhesion strength on glass reinforced epoxy substrates compared to comparative 1K radiation curable composition of Example 2.1C and comparative 2K epoxy 4.3C. Example 4.1 had much lower lap shear adhesion strength to steel than comparative 2K epoxy 4.3C. For radiation curable 1K composition 2.1C the surface remained tacky and the actinic radiation exposed material did not cure all the way through the bead. Radiation curable 1K composition 2.1C has much higher Shore hardness that the other examples as well.

### Examples 5 and 6 Two-Component Thiol/Acrylate Composition with Various SiH/Acrylate Ratio

In this example, two-component thiol/acrylate compositions with various SiH/acrylate ratios were studied. Compositions of thiol part (5.1a) and (meth)arylate parts (5.1b to 5.5b) are shown in the below table.

| sample | 5.1a | 5.1b | 5.2b | 5.3b | 5.4b | 5.5b |
|---|---|---|---|---|---|---|
| raw material | wt. % | wt. % | wt. % | wt. % | wt. % | wt. % |
| Thiol A | 65 | 0 | 0 | 0 | 0 | 0 |
| pibda | 0 | 30 | 30 | 30 | 30 | 30 |
| SR262 | 0 | 30 | 30 | 30 | 30 | 30 |
| DBU | 0 | 3 | 4.5 | 2.25 | 3.75 | 2.5 |
| CaCO3 | 34 | 35 | 33.5 | 35.75 | 34.25 | 35.5 |
| silica | 1 | 2 | 2 | 2 | 2 | 2 |
| total | 100 | 100 | 100 | 100 | 100 | 100 |

The above samples were mixed to form curable compositions. The formula (both Part A and Part B), mixing ratio and corresponding SH/acrylate ratio are shown in the Table below. Weight percents in the below 6 table are by weight of the entire mixed composition (both the thiol functional part and the (meth)acrylate functional part). Gel time, surface tack free time and Shore A hardness are summarized.

| Example | 6.1 | 6.2 | 6.3 | 6.4 | 6.5 |
|---|---|---|---|---|---|
| Mix ratio wt. % | 5.1a/5.3b | 5.1a/5.5b | 5.1a/5.1b | 5.1a/5.4b | 5.1a/5.2b |
| | 1:2 | 2:3 | 1:1 | 3:2 | 2:1 |
| Raw material | wt. % | wt. % | wt. % | wt. % | wt. % |
| Thiol A | 21.7 | 26.0 | 32.5 | 39.0 | 43.3 |
| pibda | 20.0 | 18.0 | 15.0 | 12.0 | 10.0 |
| SR262 | 20.0 | 18.0 | 15.0 | 12.0 | 10.0 |
| DBU | 1.50 | 1.50 | 1.50 | 1.50 | 1.50 |
| CaCO3 | 35.2 | 34.9 | 34.5 | 34.1 | 33.8 |
| Silica | 1.66 | 1.60 | 1.50 | 1.40 | 1.34 |
| total adhesive | 100 | 100 | 100 | 100 | 100 |
| SH/Acrylate molar ratio | 0.56 | 0.73 | 1.1 | 1.65 | 2.2 |
| Gel time (min) | 4 | 4 | 4 | 3 | 3 |
| Surface tack free time (min) | 15 | 12 | 6 | 30 | >24 hrs. |
| Shore A hardness | 25 | 40 | 45 | 25 | 5 |
| thermal resistance - Shore A | 30 | 35 | 50 | 35 | 10 |

The tested compositions had SiH/acrylate molar ranges from 0.56 to 2.2. Despite the varied SiH/acrylate ranges all the examples have a similar gel time of about 3 to 4 minutes. Examples 5.1, 5.2, 5.3 and 5.4 with SiH/acrylate ratios of 0.56-1.65 all become tack free in less than 30 min. Example 5.3 with a SiH/acrylate ratio of 1.1 had the shortest surface tacky free time and highest Shore A hardness. Surprisingly, when the SiH/acrylate ratio is less than 1.1 or higher than 1.1, the surface tack free time goes up and Shore A hardness goes down. When the SiH/acrylate ratio is 2.2, the mixed material doesn't become surface tack free in 24 hrs and Shore A hardness is low and remains low even after heating the mixed composition.

Thermal resistance of the material was tested. No significant change of Shore A hardness was observed, which is an indication of good thermal resistance of the cured compositions.

1. A curable, two component, mold blocking material, including:
a thiol part comprising a compound comprising a thiol functional group;
a (meth)acrylate part comprising a (meth)acrylate functional polymer including one or more polyolefin segments and two or more (meth)acrylate functional groups, and reactive diluent;
optionally a filler, a catalyst, an additive or a combination thereof;
wherein cured reaction products of the mixed mold blocking material have an adhesion strength of less than or equal to 1,000 psi, preferably less than 600 psi and more preferably less than 300 psi, when tested using a lap shear test and the lap shear test sample exhibits at least some adhesive failure.

2. The curable, two component, mold blocking material of claim 1, wherein the thiol part compound is a mercaptan terminated oligomer or polymer.

3. The curable, two component, mold blocking material of claim 1, wherein the thiol part compound has an average functionality of 2 or more.

4. The curable, two component, mold blocking material of claim 1, wherein the polyolefin segments in the (meth)acrylate functional polymer are selected from polybutylene, polyisobutylene, polybutadiene, polyisoprene and combinations thereof.

5. The curable, two component, mold blocking material of claim 1, wherein the (meth)acrylate functional polymer comprises two polyolefin segments connected by an aryl group.

6. The curable, two component, mold blocking material of claim 1, wherein each (meth)acrylate functional group is terminally positioned and connected to a polyolefin segment by a-(phenyl-O-alkyl)-linking group

7. The curable, two component, mold blocking material of claim 1, wherein the filler, the catalyst, the additive or the combination thereof is in the thiol part, the (meth)acrylate part or both.

8. The curable, two component, mold blocking material of claim 1, wherein the reactive diluent consists of a polyfunctional methacrylate monomer.

9. The curable, two component, mold blocking material of claim 1, wherein the cured reaction products have an at least 70%, preferably 80% and more preferably greater than 90% adhesive failure mode.

10. The mold blocking material of claim 1, wherein the mixed mold blocking material has a gel time of 1 to 30 minutes; and/or a surface tack free time of 1 to 60 minutes; and/or a room temperature cure time of 1 hour to 168 hours.

11. The curable, two component, mold blocking material of claim 1, wherein the cured reaction products have a room temperature cure hardness of 20 to 80 Shore A; and/or a thermal resistance of 20 to 90 Shore A.

12. (canceled)
